(19) United States
(12) Patent Application Publication
(10) Pub. No.: US 2003/0002970 A1
(43) Pub. Date: Jan. 2, 2003

(54) End effector for lifting semiconductor wafer carrier

(75) Inventors: Martin R. Elliott, Round Rock, TX (US); Jeffrey C. Hudgens, San Francisco, CA (US)

Correspondence Address: APPLIED MATERIALS, INC., 2881 SCOTT BLVD. M/S 2061, SANTA CLARA, CA, 95050, US

(73) Assignee: Applied Materials, Inc.

(21) Appl. No.: 09/894,322

(22) Filed: Jun. 27, 2001

(51) Int. Cl. B65G 49/07

(52) U.S. Cl. 414/619

(57) ABSTRACT

An end effector is adapted to lift a wafer carrier. The end effector includes a substantially planar, horizontally-extending support member, and a pair of fingers extending downwardly from the support member to define a T-shaped slot. In one embodiment at least one of the fingers includes an inwardly-and downwardly-extending inclined surface. One or more of the fingers may include a horizontal surface extending inwardly from a lower edge of the inclined surface. The inclined surface(s) kinematically position the wafer carrier in a pre-determined manner relative to the end effector. In another embodiment a horizontal locating pin may be provided on one of the fingers.

### FIELD OF THE INVENTION

The present invention relates to semiconductor manufacturing, and more particularly to an apparatus for moving a carrier in which semiconductor substrates are stored.

### BACKGROUND OF THE INVENTION

Semiconductor devices are made on substrates, such as silicon wafers or glass plates, for use in computers, monitors, and the like. These devices are made by a sequence of fabrication steps, such as thin film deposition, oxidation or nitration, etching, polishing, and thermal and lithographic processing. Although multiple fabrication steps may be performed in a single processing station, substrates must be transported between processing stations for at least some of the fabrication steps.

Substrates are stored in cassettes or pods (hereinafter referred to collectively as “wafer carriers”) for transfer between processing stations and other locations. Although wafer carriers may be carried manually between processing stations, the transfer of wafer carriers is typically automated. For instance, automatic handling of a wafer carrier may be performed by a robot, which lifts the wafer carrier by means of a end effector. As one example, end effectors have been proposed to lift a wafer carrier by engaging a flange provided at the top of the wafer carrier. One known type of end effector includes a support plate and fingers extending downwardly and inwardly from the support plate to define a “T”-shaped slot. The slot may be moved horizontally over and around the carrier flange. Pins may be provided that protrude upwardly from the end effector fingers to mate with detents provided on the flange.

Successful operation of robots that transport wafer carriers requires that the movements of the robot be controlled with a high degree of precision. It would be desirable to provide a end effector that is forgiving of, and automatically compensates for, minor errors in the positioning of the end effector relative to the wafer carrier.

### SUMMARY OF THE INVENTION

According to an aspect of the invention, there is provided a end effector adapted to lift a wafer carrier. The end effector includes a substantially planar, horizontally-extending support member, and a pair of fingers extending downwardly from the support member to define a slot. At least one of the fingers includes an inwardly-and downwardly-extending inclined surface. Preferably each of the fingers includes an inwardly-and downwardly-extending inclined surface, and a horizontal surface extending inwardly from a lower edge of the inclined surface.

The respective lower edges of the inclined surfaces may be spaced from each other by a distance that corresponds to a width of a flange mounted on top of the wafer carrier to be lifted by the end effector. Each finger may include a vertical surface that extends from the respective inclined surface to the support member. The support member may have a hole formed therein above the slot defined by the pair of fingers. The support member may also include an attachment portion adapted to be attached to a lift mechanism.

The end effector may further include a first pin extending horizontally inward from the inclined surface of one of the fingers. The end effector may include a second pin spaced from the first pin and extending vertically upward from the horizontal surface of one of the fingers. The end effector may further include a third pin extending vertically upward from the horizontal surface of the other one of the fingers.

According to another aspect of the invention, a method of transporting a wafer carrier includes engaging an overhead transport (OHT) flange of the wafer carrier with fingers that extend downwardly from a end effector. The method further includes lifting the wafer carrier by means of the fingers, and, during the lifting step, guiding the OHT flange in a horizontal direction by means of an inclined surface provided on at least one of the fingers.

The inclined surface(s) provided on the end effector fingers in accordance with the invention cooperate with the top flange of the wafer carrier to be lifted, so as to passively guide the wafer carrier to a centered position relative to the end effector. Thus, the configuration of the fingers including the inclined surfaces kinematically positions the wafer carrier relative to the end effector and automatically compensates for an initial degree of mispositioning of the end effector relative to the wafer carrier.

Furthermore, according to another aspect of the invention, a horizontal pin provided on one of the fingers cooperates with a feature (e.g., a semicircular groove) formed on the flange of the wafer carrier to accurately position the wafer carrier in a lateral direction. Thus, aspects of the invention may include such an inventive horizontal locating pin and/or one or more inventive inclined surfaces, or may employ either or both of these features to kinematically position a wafer carrier.

Further features and advantages of the present invention will become more fully apparent from the following detailed description of the preferred embodiments, the appended claims and the accompanying drawings.

### BRIEF DESCRIPTION OF THE DRAWINGS

FIG. 1 is an isometric view, from above, of an end effector provided in accordance with the invention;

FIG. 2 is a side view of the end effector of FIG. 1;

FIG. 3 is a top plan view of the end effector of FIG. 1;

FIG. 4 is a side view showing the end effector of FIG. 1 suitably positioned to lift a wafer carrier; and

FIG. 5 is a view similar to FIG. 2 showing an end effector provided according to an alternative embodiment of the invention.

### DESCRIPTION OF THE PREFERRED EMBODIMENTS

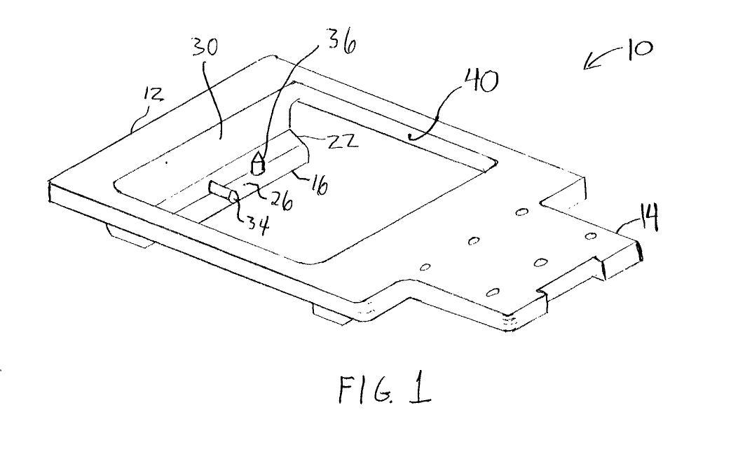

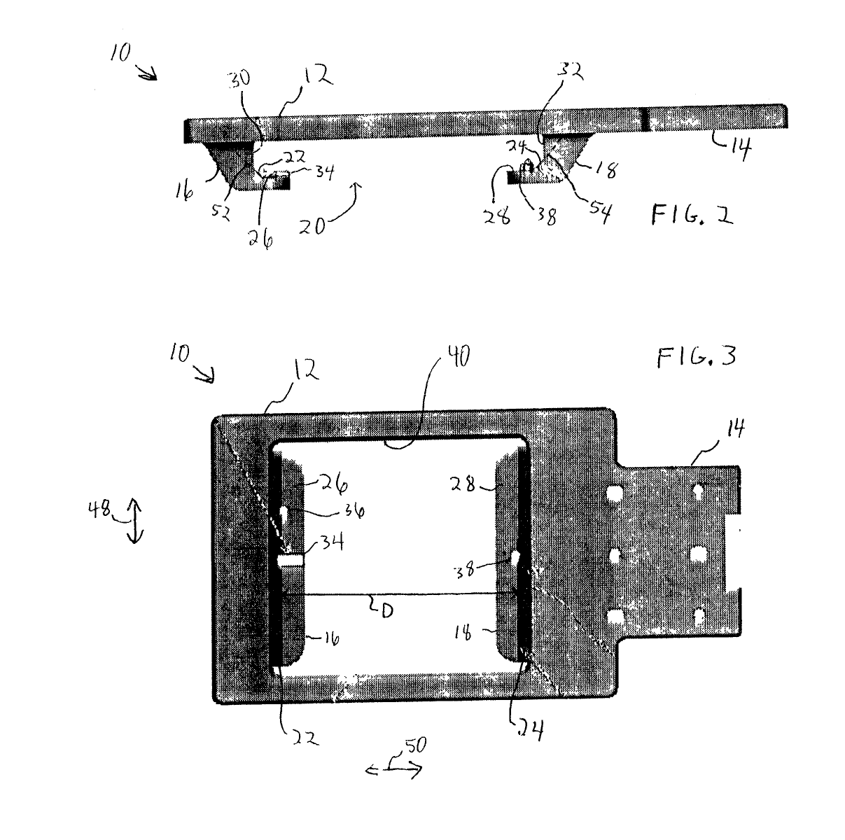

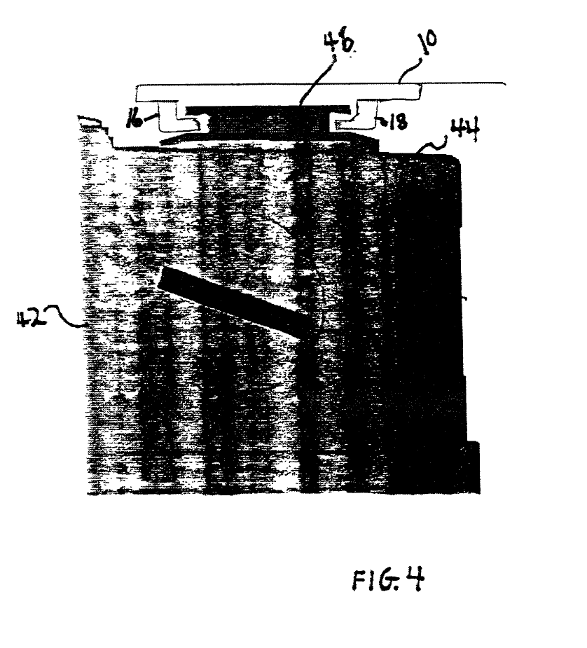

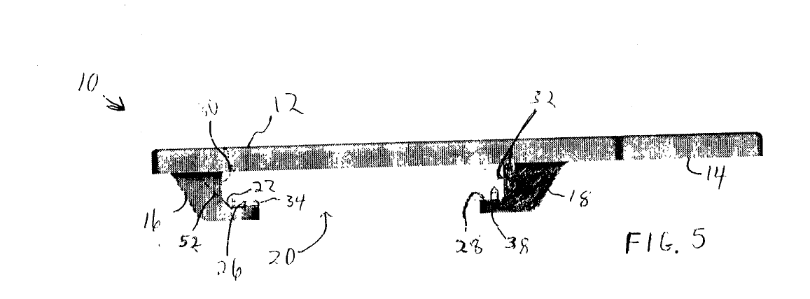

An end effector provided in accordance with aspects of the invention will now be described, with reference to FIGS. 1-4. FIG. 1 is an isometric view, from above, of the inventive end effector. FIGS. 2 and 3 are side and top plan views, respectively, and FIG. 4 is a side view that shows the inventive end effector positioned to lift a wafer carrier.

In the drawings, reference numeral 10 generally indicates the end effector. The end effector 10 may be formed of metal such as aluminum or stainless steel. The end effector 10 may include a generally planar support member 12. At one end of the support member 12 an attachment portion 14 may be formed. The attachment portion 14 may be used to attach the end effector 10 to a lift mechanism, which is not shown.

Fingers 16 and 18 extend downwardly from the support member 12. The fingers 16, 18 are spaced from each other and configured so as to define therebetween a T-shaped slot 20, as best seen in FIG. 2. Finger 16 includes an inclined surface 22 that extends inwardly and downwardly at one side of the T-shaped slot 20, and finger 18 has an inclined surface 24 that extends inwardly and downwardly at the other side of the T-shaped slot 20. A first horizontal lifting surface 26 may extend inwardly from a lower edge of the inclined surface 22, and a second horizontal lifting surface 28 may extend inwardly from a lower edge of the inclined surface 24. A vertical surface 30 may extend upwardly from the inclined surface 22 to the support member 12, and a vertical surface 32 may extend upwardly from the inclined surface 24 to the support member 12.

A horizontal locating pin 34, best seen in FIGS. 1 and 3, which may be provided on the finger 16 extends inwardly above the horizontal surface 26. Also provided on the finger 16 may be a first vertical locating pin 36, which extends upwardly from the horizontal surface 26. A second vertical locating pin 38 (FIGS. 2 and 3) which may be provided on finger 18 extends upwardly from the horizontal surface 28. As used herein, a locating pin is a mechanism designed to interface with a wafer carrier's overhead transport flange so as to guide the overhead transport flange to a predetermined position relative to the end effector 10.

A large hole 40 (FIGS. 1 and 3) may be is formed in the support member 12 above the slot 20 (FIG. 2). The purpose of the hole 40 is to reduce the weight of the end effector 10.

FIG. 4 shows the end effector 10 in juxtaposition with a wafer carrier 42 to be lifted by the end effector 10. The wafer carrier 42 is of a standard type known as a front opening unified pod (FOUP). The wafer carrier 42 has a top surface 44 on which is mounted a flange 46. The flange 46 is of the type referred to as an overhead transport (OHT) flange.

In operation the end effector 10 is moved in a lateral direction (i.e., one of the directions indicated by the double headed arrow 48 in FIG. 3) to be brought into the position indicated in FIG. 4 with the T-shaped slot 20 positioned around and below the flange 46. The end effector 10 is then raised. The flange 46 is engaged by the fingers 16, 18 and the wafer carrier 42 is lifted. To the extent that the end effector 10 is positioned off-center relative to the flange 46 in the fore-and-aft direction (indicated by double headed arrow 50 in FIG. 3), a corresponding one of the inclined surfaces 22, 24 kinematically guides the flange 46 in a horizontal (fore-and-aft) direction so as to center the wafer carrier 42 relative to the end effector 10. For this purpose, the respective lower edges of the inclined surfaces 22 and 24 may be spaced from each other precisely by a distance D (FIG. 3), which distance D is equal to the width of the flange 46 in the fore-and-aft direction.

At the same time, horizontal locating pin 34 cooperates kinematically with a semicircular groove (not shown) in the flange 46, and vertical locating pins 36 and 38 cooperate with respective V-shaped slots (not shown) in the flange 46, to accurately position the wafer carrier 42 in the lateral direction (referenced by double headed arrow mark 48, FIG. 3). Thus the end effector 10 is arranged to passively and kinematically obtain accurate positioning of the wafer carrier 42 in both the lateral and fore-and-aft directions. The end effector 10 may have no moving parts and therefore may be inexpensive to manufacture.

The end effector 10 of the present invention is suitable for use in connection with a robotic cassette mover of the type shown in a co-pending and commonly-assigned U.S. patent application entitled “Apparatus for Storing and Moving a Cassette”, Ser. No. 09/201,737, filed Dec. 1, 1998, and incorporated herein by reference in its entirety.

The foregoing description discloses only a preferred embodiment of the invention; modifications of the above disclosed apparatus which fall within the scope of the invention will be readily apparent to those of ordinary skill in the art. For example, it is contemplated to replace the horizontal locating pin 34 with another vertical locating pin. However, the horizontal locating pin 34 is preferred, because it has a larger capture area than a vertical locating pin would have.

It is also contemplated to replace the vertical surfaces 30, 32 (FIG. 2) with inclined surfaces (indicated by dotted lines at 52, 54) to join the inclined surfaces 22, 24 with the support member 12. It is to be understood that even with such extended inclined surfaces, the slot 20 remains T-shaped. Similarly, the horizontal surfaces 26 and 28 may be omitted, and any of the optional horizontally and/or vertically extending pins 34, 36, 38 may extend from appropriate locations on the inclined surfaces 22, 24. Such an embodiment may employ inclined surfaces 22, 24 that have lower edges that are narrower than the width of the flange 46, as may other embodiments. It should also be understood that the end effector shown in the figures may be modified (1) so as to kinematically position a wafer carrier via a single inclined surface (e.g., with one finger having an inclined surface 52 and the opposing finger having a vertical surface 32 and a horizontally extending support surface 28, wherein the inclined vertical surfaces 52, 32 define an opening equal to the width of an OHT flange of a wafer carrier to be lifted by the end effector, as shown in FIG. 5; or (2) so as to kinematically position a wafer carrier between two the two inclined surfaces at positions other than the lower edge of the inclined surfaces (e.g., any horizontally opposed points along the inclined surfaces may define a space equal to the width of an OHT flange to be supported thereby—such surfaces are referred to herein as “horizontally spaced from each other by a distance that corresponds to the width of the OHT flange.”

Moreover, although the end effector 10 disclosed herein is useful for transporting a substrate carrier of the type known as a FOUP and used for 300 mm wafers, it is also contemplated that a like end effector may be employed for other types of substrate carrier having an overhead flange, including the well known SMIF (standard mechanical interface) pod used for 200 mm wafers.

Accordingly, while the present invention has been disclosed in connection with a preferred embodiment thereof, it should be understood that other embodiments may fall within the spirit and scope of the invention, as defined by the following claims.

The invention claimed is:

1. An end effector adapted to lift a wafer carrier, comprising:
a horizontally-extending support member; and
a pair of fingers extending downwardly from the support member to define a slot;
each of the fingers including an inwardly-and downwardly-extending inclined surface horizontally spaced from each other by a distance that corresponds to a width of a flange mounted on top of the wafer carrier to be lifted by the end effector.

2. The end effector of claim 1, further comprising a horizontal surface extending inwardly from a lower edge of the inclined surface wherein each inclined surface has a lower edge, the respective lower edges being horizontally spaced from each other by a distance that corresponds to a width of a flange mounted on top of the wafer carrier to be lifted by the end effector.

3. The end effector of claim 1, wherein each finger includes a vertical surface that extends from the respective inclined surface to the support member.

4. The end effector of claim 1, wherein the support member has a hole formed therein above the slot defined by the pair of fingers.

5. The end effector of claim 1, wherein the support member includes an attachment portion adapted to be attached to a lift mechanism.

6. The end effector of claim 1, further comprising a first locating pin extending horizontally inwardly from the inclined surface of one of the fingers.

7. The end effector of claim 6, further comprising a second locating pin spaced from the first pin and extending vertically upwardly from the horizontal surface of said one of the fingers.

8. The end effector of claim 7, further comprising a third locating pin extending vertically upwardly from the horizontal surface of the other one of the fingers.

9. A end effector adapted to lift a wafer carrier, comprising:
a substantially planar, horizontally-extending support member;
a pair of fingers extending downwardly from the support member to define a slot; and
a horizontal locating pin extending inwardly from one of the fingers.

10. The end effector of claim 9, further comprising a first vertical locating pin extending upwardly from said one of the fingers.

11. The end effector of claim 10, further comprising a second vertical locating pin extending upwardly from the other one of the fingers.

12. A method of transporting a wafer carrier, comprising the steps of:
engaging an overhead transport (OHT) flange of the wafer carrier with fingers that extend downwardly from a end effector;
lifting the wafer carrier by means of the fingers; and
during the lifting step, guiding the OHT flange in a first horizontal direction to a position predetermined in the first horizontal direction via an inclined surface provided on at least one of the fingers.

13. The method of claim 12 further comprising during the lifting step guiding the OHT flange in a second horizontal direction to a position predetermined in the second horizontal direction.

14. The method of claim 13 wherein the first horizontal direction and the second horizontal direction are perpendicular to each other.

15. An end effector adapted to lift a wafer carrier, comprising:
a horizontally-extending support member; and
a pair of fingers extending downwardly from the support member to define a slot;
at least one of the fingers including an inwardly-and downwardly-extending inclined surface horizontally spaced from each other by a distance that corresponds to a width of a flange mounted on top of the wafer carrier to be lifted by the end effector.

16. The end effector of claim 15, further comprising a first locating pin extending horizontally inwardly from the inclined surface of one of the fingers.

17. The end effector of claim 16, further comprising a second locating pin spaced from the first pin and extending vertically upwardly from the horizontal surface of said one of the fingers.

18. The end effector of claim 17, further comprising a third locating pin extending vertically upwardly from the horizontal surface of the other one of the fingers.
